(19) United States
(12) Patent Application Publication
(10) Pub. No.: US 2015/0003987 A1
(43) Pub. Date: Jan. 1, 2015

(54) VIBRATION-PROOF MEMBER AND FAN ASSEMBLY HAVING THE SAME

(71) Applicants: HON HAI PRECISION INDUSTRY CO., LTD., New Taipei (TW); HONG FU JIN PRECISION INDUSTRY (ShenZhen) CO., LTD., ShenZhen (CN)

(72) Inventor: LI-REN FU, Shenzhen (CN)

(73) Assignees: HON HAI PRECISION INDUSTRY CO., LTD., New Taipei (TW); HONG FU JIN PRECISION INDUSTRY (ShenZhen) CO., LTD., ShenZhen (CN)

(21) Appl. No.: 13/966,251

(22) Filed: Aug. 13, 2013

(30) Foreign Application Priority Data
Jun. 28, 2013 (CN) 2013102640192

(51) Int. Cl. F01D 25/04; F16F 15/08; F16F 1/373

(52) U.S. Cl. CPC F01D 25/04; F16F 1/3737; F16F 15/08
USPC 416/190; 267/141

(57) ABSTRACT

A vibration-proof member for a cooling fan includes a plate to absorb vibration, a post perpendicularly extending out from a side of the absorbing plate, and an extending portion perpendicularly extending out from a part of a lateral side of the absorbing plate. The construction and method of installing the vibration-proof member allows any required number of the vibration-proof members to be installed and to function effectively whether the fan is installed on a vertical bracket or on a horizontal bracket.

### BACKGROUND

1. Technical Field

The present disclosure relates to smoothing the operation of a fan assembly.

2. Description of Related Art

Vibration-proof members mounted to an end board of a fan often include a flat and thin vibration-absorbing plate abutting an outer surface of the end board. These vibration-proof members are generally made of rubber and are thin and flat, as a result, when the fan with the vibration-proof members is put into a chassis from top to bottom, the absorbing plates are easily folded.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a fan assembly.

FIG. 2 is an assembled, isometric view of the fan assembly of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

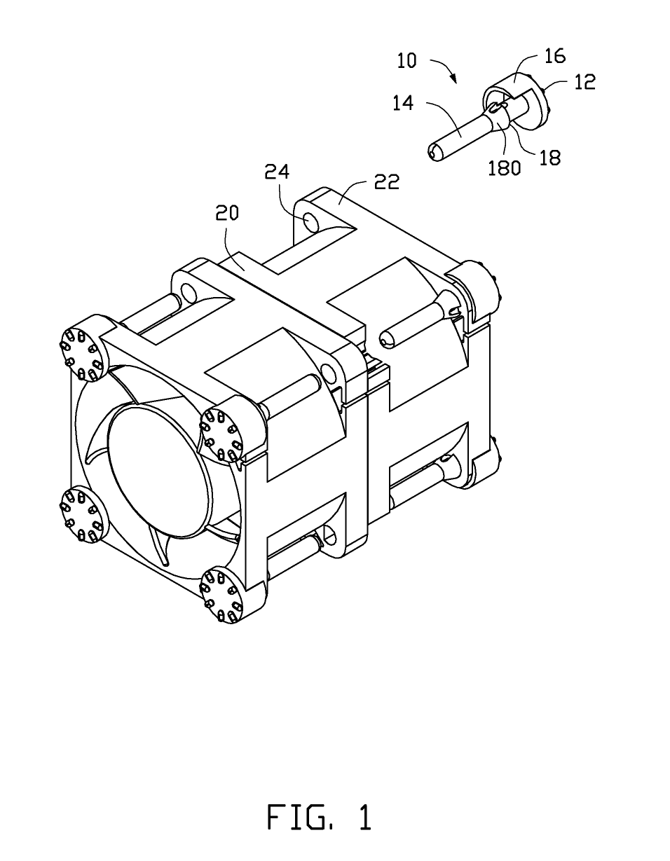

Referring to FIG. 1, an embodiment of a fan assembly includes a fan 20 and a vibration-proof member 10 mounted to the fan 20. The fan 20 includes a rectangular end board 22. The end board 22 defines four through holes 24 in four corners. The four corners are rounded and not sharp.

The vibration-proof member 10 is made of rubber, and includes a round vibration-absorbing plate 12, a post 14 perpendicularly extending out from a side of the vibration-absorbing plate 12, and an extending portion 16 perpendicularly extending out from a part of a circumference of the vibration-absorbing plate 12. A cross-section of the extending portion 16 is arc-shaped. An annular protrusion 18 protrudes from a circumference of the post 14. A surface 180 of the protrusion 18 away from the post 14 is tapered toward a distal end of the post 14.

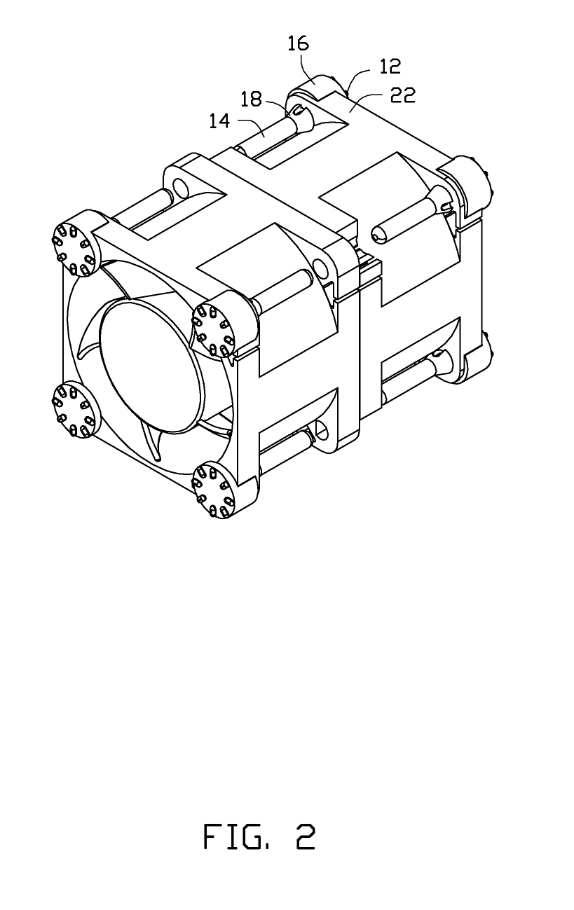

Referring to FIG. 2, in use, the post 14 extends through one of the through holes 24, until the vibration-absorbing plate 12 contacts an outer surface of the end board 22. The protrusion 18 abuts an inner surface of the end board 22. The extending portion 16 fits and encloses a rounded corner.

Three other vibration-proof members 10 can be mounted to the end board 22 in the same way.

Because the extending portions 16 enclosure the rounded corners of the end board 22, when the fan 20 is put into a chassis from top to bottom, the vibration absorbing plates 12 will not drop or suffer misalignment.

In another embodiment, in case the corners of the end board 22 are right angled and sharp, the vibration-absorbing plate 12 is rectangular, and the extending portion 16 is L-shaped. When the corners of the end board 22 have particular other shapes, the forms of the absorbing plate 12 and the extending portion 16 will be changed to fit.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A vibration-proof member, comprising:
a vibration-absorbing plate;
a post perpendicularly extending out from a side of the absorbing plate; and
an extending portion perpendicularly extending out from a part of a lateral side of the absorbing plate.

2. The vibration-proof member of claim 1, wherein the absorbing plate is round, the extending portion perpendicularly extends out from a part of a circumference of the absorbing plate and has an arc-shaped cross-section.

3. The vibration-proof member of claim 1, wherein an annular protrusion protrudes from a circumference of the post.

4. The vibration-proof member of claim 3, wherein a surface of the protrusion away from the post is tapered toward a distal end of the post.

5. A fan assembly, comprising:
a fan comprising an end board defining a plurality of through holes; and
a plurality of vibration-proof members; each vibration-proof member comprising:
a vibration-absorbing plate contacting an outer surface of the end board;
a post perpendicularly extending out from a side of the absorbing plate to extend through one of the through holes; and
an extending portion perpendicularly extending out from a part of a lateral side of the absorbing plate and contacting a lateral side of the end board.

6. The fan assembly of claim 5, wherein the end board is rectangular, the lateral sides of four corners of the end board are round corners, the absorbing plate is round, the extending portion perpendicularly extends out from a part of a circumference of the absorbing plate and has an arc-shaped cross-section, each extending portion enclosures one of the round corners.

7. The fan assembly of claim 5, wherein an annular protrusion protrudes from a circumference of the post to abut an inner surface of the end board.

8. The fan assembly of claim 7, wherein a surface of the protrusion away from the post is tapered toward a distal end of the post.
